(19) United States
(12) Patent Application Publication
(10) Pub. No.: US 2026/0071297 A1
(43) Pub. Date: Mar. 12, 2026

(54) GOLD RECOVERY SYSTEM AND RECOVERY METHOD THEREOF FROM GOLD SEPARATION SOLUTION

(71) Applicant: COPPER BRANCH COMPANY OF YUNNAN TIN COMPANY LMITED, HONGHE (CN)

(72) Inventors: BING CAI, HONGHE (CN); XIANHUI ZHOU, HONGHE (CN); YONGCHUN LUO, HONGHE (CN); FENG YE, HONGHE (CN); ZIHUI MA, HONGHE (CN); SHAOZENG PU, HONGHE (CN); GANG CHEN, HONGHE (CN); JIE DOU, HONGHE (CN); KAI LI, HONGHE (CN); JIHANG ZHU, HONGHE (CN); XIANG PU, HONGHE (CN); JIFENG YANG, HONGHE (CN)

(21) Appl. No.: 19/389,497

(22) Filed: Nov. 14, 2025

Related U.S. Application Data
(63) Continuation-in-part of application No. PCT/CN2025/118390, filed on Sep. 2, 2025.

(30) Foreign Application Priority Data
Sep. 3, 2024 (CN) 202411227620.9

(51) Int. Cl. C22B 11/00; C22B 3/40

(52) U.S. Cl. CPC C22B 11/04; C22B 3/406

(57) ABSTRACT

The present application discloses a gold recovery system and recovery method thereof from a gold separation solution, where the recovery system includes an gold selective extraction system, a reduction system, a washing system, and an evaporation system; and the recovery method specifically includes the following steps: (1) primary extraction; (2) secondary extraction; (3) gold precipitation by reduction; (4) washing of gold powder; and (5) evaporation of waste solution. In the present application, by using chloride ions to recognize AuCl₄⁻, the gold-rich solution is directly reduced to produce qualified gold powder product (99.995%); the gold-barren solution and the post-reduction solution are evaporated and concentrated, with the condensate reused to realize the recovery and regeneration of chloride ions, the recycling of the extractant and no generation of waste solution or waste gas in the production process.

### CROSS-REFERENCE TO RELATED APPLICATIONS

The present application is a continuation-in-part application of international patent application No. PCT/CN2025/118390 filed on Sep. 2, 2025, which claims priority to Chinese patent application number 202411227620.9 filed with the Chinese Patent Office on Sep. 3, 2024, and entitled “GOLD RECOVERY SYSTEM AND RECOVERY METHOD THEREOF FROM GOLD SEPARATION SOLUTION”, the entire contents of which are incorporated by reference herein.

### TECHNICAL FIELD

The present application relates to the technical field of hydrometallurgy of precious metals, and more particularly to a gold recovery system and recovery method thereof from a gold separation solution.

### BACKGROUND ART

There are many gold recovery methods from gold separation solutions, but all have certain limitations. Gold production methods commonly employ the reduction-electrolysis-melting method and reduction-chlorination-reduction method, where the method adopting reduction-electrolysis has a large system inventory and has requirements on the composition of the gold anode plate; and the method adopting reduction-chlorination-reduction involves a long process, low direct gold recovery, poor reduction agent selectivity, poor operating environment, and unstable gold quality.

As the composition of raw materials becomes complex, the gold concentrations of gold separation solutions vary greatly across plants, making it generally difficult to produce qualified gold in a single step from low-concentration gold separation solutions, and thus all requiring enrichment and refining processes.

Therefore, it is a problem to be solved urgently by those skilled in the art to develop a gold production system and method that are highly selective, highly adaptable, efficient, and environmentally friendly.

### SUMMARY

One or more embodiments of the present application provide a gold recovery system from a gold separation solution, including a gold selective extraction system, a reduction system, a washing system, and an evaporation system;
where the gold selective extraction system includes a gold separation solution mixer, a gold separation solution metering tank, a gold-carrying solution storage tank, a gold-carrying solution metering tank, an extractant storage tank, an extractant metering tank, a first extraction reactor, a second extraction reactor, a gold-rich solution pump, a secondary gold separation solution pump, a gold-rich solution storage tank, a secondary gold separation solution mixer, a gold-carrying solution pump, a gold-barren solution mixer and a gold-barren solution pump; the gold separation solution mixer is connected to the gold separation solution metering tank and the first extraction reactor in sequence, the gold-carrying solution storage tank is connected to the gold-carrying solution metering tank and the first extraction reactor in sequence, the extractant storage tank is connected to extractant metering tank and the first extraction reactor in sequence, the first extraction reactor is connected to gold-rich solution pump, gold-rich solution storage tank and reduction system in sequence; and the extractant storage tank is connected to the extractant metering tank and the second extraction reactor in sequence, the first extraction reactor is connected to the secondary gold separation solution pump, the secondary gold separation solution mixer, and the second extraction reactor in sequence, the second extraction reactor is connected to the gold-carrying solution pump and the gold-carrying solution storage tank in sequence, and the second extraction reactor is connected to the gold-barren solution pump, the gold-barren solution mixer, and the evaporation system in sequence;
the reduction system includes a reduction reactor, a reduction agent preparation tank, a post-reduction solution storage tank, an oil phase pump, and a liquid phase pump; and the gold-rich solution storage tank is connected to the reduction reactor and the washing system in sequence, the reduction agent preparation tank is connected to the reduction reactor, the reduction reactor is connected to the oil phase pump and the extractant storage tank in sequence, and the reduction reactor is connected to the liquid phase pump, the post-reduction solution storage tank, and the evaporation system in sequence;
the washing system includes a washing barrel, a hydrochloric acid washing tank, a nitric acid washing tank, an ammonia washing tank and a pure water washing tank; and the reduction reactor is connected to the washing barrel, and the hydrochloric acid washing tank, the nitric acid washing tank, the ammonia washing tank and the pure water washing tank are respectively connected to the washing barrel; and
the evaporation system includes an evaporator, a condenser, a circulation tank, a circulation pump, an acid solution tank, a cold water barrel and a hot water barrel; and the gold-barren solution mixer and the post-reduction solution storage tank are respectively connected to the circulation tank, the circulation pump, the evaporator, the condenser and the acid solution tank in sequence, and the cold water barrel and the hot water barrel are respectively connected to the condenser.

A gold recovery method from a gold separation solution, using the above recovery system, specifically includes the following steps:

### (1) Primary Extraction

discharging the gold separation solution in the gold separation solution mixer to the first extraction reactor via the gold separation solution metering tank, discharging the extractant A in the extractant storage tank to the first extraction reactor via the extractant metering tank, then starting the agitator of the first extraction reactor to make the gold separation solution and the extractant fully react, standing for separation to obtain the gold-rich solution and the secondary gold separation solution respectively, and finally, discharging the gold-rich solution to the gold-rich solution storage tank via the gold-rich solution pump, and discharging the secondary gold separation solution to the secondary gold separation solution mixer via the secondary gold separation solution pump;

### (2) Secondary Extraction

discharging the secondary gold separation solution in the secondary gold separation solution mixer to the second extraction reactor, discharging the extractant B in the extractant storage tank to the second extraction reactor via the extractant metering tank, then starting the agitator of the second extraction reactor to make the secondary gold separation solution and the extractant fully react, standing for separation to obtain a gold-carrying solution and a gold-barren solution respectively, and finally discharging the gold-carrying solution to the gold-carrying solution storage tank via the gold-carrying solution pump, and discharging the gold-barren solution to the gold-barren solution mixer via a gold-barren solution pump;

### (3) Gold Precipitation by Reduction

discharging the gold-rich solution in the gold-rich solution storage tank to the reduction reactor, starting the agitator of the reduction reactor, heating, then discharging the reduction agent in the reduction agent preparation tank to the reduction reactor, making the gold-rich solution and the reduction agent fully react, cooling, standing for separation to obtain an extractant, a post-reduction solution, and gold powder respectively, and finally, discharging the extractant to the extractant storage tank via the oil phase pump, discharging the post-reduction solution to the post-reduction solution storage tank via the liquid phase pump, and discharging the gold powder to the washing barrel via a bottom valve of the reduction reactor;

### (4) Washing of Gold Powder

introducing the steam to the washing barrel for hot washing; discharging the hydrochloric acid in the hydrochloric acid washing tank to the washing barrel, soak washing, filtering, discharging the obtained hydrochloric acid concentrated solution to the hydrochloric acid washing tank, and discharging the pure water in the pure water washing tank to the washing barrel and washing until neutral; discharging the ammonia water in the ammonia washing tank to the washing barrel, soak washing, filtering, discharging the obtained ammonia concentrated solution to the ammonia washing tank, and discharging the pure water in the pure water washing tank to the washing barrel and washing until neutral; discharging the nitric acid in the nitric acid washing tank to the washing barrel, soak washing, filtering, discharging the obtained nitric acid concentrated solution to the nitric acid washing tank, and discharging the pure water in the pure water washing tank to the washing barrel and washing until neutral; and drying the gold powder in the washing barrel to obtain the gold powder product; and

### (5) Evaporation of Waste Solution

discharging the gold-barren solution in the gold-barren solution mixer and the post-reduction solution in the post-reduction solution storage tank to the evaporator through the circulation tank and the circulation pump respectively, simultaneously opening the steam valve of the evaporator, adjusting the opening degree for evaporation and concentration to obtain a gold-barren solution concentrate, a post-reduction solution concentrate and an evaporated acid mist respectively, further recovering valuable metals selenium and tellurium from the gold-barren solution concentrate, returning the post-reduction solution concentrate to the reduction agent preparation tank, discharging the evaporated acid mist to the condenser, and simultaneously opening the cold water barrel and the hot water barrel for condensation, and discharging the obtained acid solution to the acid solution tank.

In one or more embodiments, in step (1), the composition of the gold separation solution includes: Au (gold) 0.30-0.38 g/L, Ag (silver) 0.05-0.15 g/L, Pt (platinum) 3 mg/L, Pd (palladium) 30 mg/L, Se (selenium) 0.9-1.5 g/L, Te (tellurium) 10-13 g/L, Bi (bismuth) 8 g/L, As (arsenic) 4 g/L and Cu (copper) 0.6-1.3 g/L.

In one or more embodiments, in step (1), the composition of the gold separation solution includes: Au 0.30 g/L, Ag 0.15 g/L, Pt 3 mg/L, Pd 30 mg/L, Se 1.5 g/L, Te 10 g/L, Bi 8 g/L, As 4 g/L and Cu 0.6 g/L.

In one or more embodiments, in step (1), the extractant A is a mixed solution of pillararene and chloroform.

In one or more embodiments, in step (1), the molar concentration ratio of pillararene to chloroform is (8-10):1.

In one or more embodiments, in step (1), the volume ratio of the gold separation solution to the extractant is 1:(0.8-1).

In one or more embodiments, in step (1), the volume ratio of the gold separation solution to the extractant is 1:1.

In one or more embodiments, in step (1), for the reaction, the temperature is 25° C. (normal temperature), and the time is 2-3 h.

In one or more embodiments, in step (1), for the reaction, the temperature is 25° C. (normal temperature), and the time is 2 h.

In one or more embodiments, in step (2), the extractant B is a mixed solution of pillararene and chloroform.

In one or more embodiments, in step (2), the molar concentration ratio of pillararene to chloroform is (15-20):1.

In one or more embodiments, in step (2), the volume ratio of the secondary gold separation solution to the extractant is 1:(0.8-1).

In one or more embodiments, in step (2), the volume ratio of the secondary gold separation solution to the extractant is 1:0.8.

In one or more embodiments, in step (2), for the reaction, the temperature is 25° C. (normal temperature), and the time is 1-2 h.

In one or more embodiments, in step (2), for the reaction, the temperature is 25° C. (normal temperature), and the time is 2 h.

In one or more embodiments, in step (3), the reduction agent is ammonium oxalate.

In one or more embodiments, in step (3), the dosage of ammonium oxalate is 1.5 times the mass of gold in the gold-rich solution.

In one or more embodiments, in step (3), the reaction temperature is 85-95° C., and the reaction time is 4-6 h.

In one or more embodiments, in step (3), the reaction temperature is 85° C., and the reaction time is 4 h.

In one or more embodiments, in step (5), the steam flow rate of evaporation and concentration is 0.5 m³/h.

In one or more embodiments, in step (5), the circulation flow rate of the gold-barren solution and the post-reduction solution is 80 L/h.

In one or more embodiments, in step (5), the flow rate of cooling water for the condensation is 50 L/h.

The present application further seeks to protect the use of the above-mentioned gold recovery system from a gold separation solution or the above-mentioned gold recovery method from a gold separation solution in recovering the gold separation solution.

It can be seen from the technical solutions that compared with the prior art, the beneficial effects of the present application are as follows.
1. The present application adopts a selective extractant to selectively recognize AuCl₄⁻ ions from a gold separation solution, thereby achieving an effective separation of gold from other elements; and the gold-rich solution is reduced to obtain gold, the gold-barren solution and the post-reduction solution are evaporated to achieve acid recycling, and the extractant and the reduction agent are recycled to achieve zero emission of waste solution and waste gas.
2. In the present application, the process is smooth and easy to operate, the selective ion recognition enables thorough separation of gold and impurity elements, the system does not involve cyanide, sulfide, nitrogen oxide and sodium ions in traditional gold recovery processes, decreasing the cost of wastewater treatment and enabling high efficiency and environmental protection performance. The entire system has no discharge of waste solution and waste gas, and may achieve “one-step gold extraction”. It has the advantages of low cost, high gold recovery rate and high quality, strong recognition ability, stability, strong adaptability, high efficiency and speed, etc.

### BRIEF DESCRIPTION OF DRAWINGS

In order to more clearly illustrate the technical solutions of the embodiments of the present application or in the prior art, the drawings required for use in description of the embodiments or the prior art will be briefly introduced below. Obviously, the drawings described below are merely embodiments of the present application. For a person ordinarily skilled in the art, other drawings may be obtained based on the provided drawings without paying any creative work.

FIG. 1 is a schematic structural diagram of a gold recovery system from a gold separation solution of the present application; and

FIG. 2 is a process flow chart of gold recovery method from a gold separation solution of the present application.

### DESCRIPTION OF REFERENCE SIGNS

1—gold separation solution mixer, 2—gold separation solution metering tank, 3—gold-carrying solution storage tank, 4—gold-carrying solution metering tank, 5—extractant storage tank, 6—extractant metering tank, 7—first extraction reactor, 8—second extraction reactor, 9—gold-rich solution pump, 10—secondary gold separation solution pump, 11—gold-rich solution storage tank, 12—secondary gold separation solution mixer, 13—gold-carrying solution pump, 14—gold-barren solution mixer, 15—gold-barren solution pump, 16—reduction reactor, 17—reduction agent preparation tank, 18—post-reduction solution storage tank, 19—oil phase pump, 20—liquid phase pump, 21—washing barrel, 22—hydrochloric acid washing tank, 23—nitric acid washing tank, 24—ammonia washing tank, 25—pure water washing tank, 26—evaporator, 27—condenser, 28—circulation tank, 29—circulation pump, 30—acid solution tank, 31—cold water barrel, 32—hot water barrel.

### DETAILED DESCRIPTION OF EMBODIMENTS

To make the purposes, technical solutions, and advantages of the embodiments of the present application clearer, the technical solutions in the embodiments of the present application will be clearly and completely described below in conjunction with the drawings in the embodiments of the present application. Obviously, the described embodiments are only some of the embodiments of the present application, not all of the embodiments. Based on the embodiments of the present application, all other embodiments obtained by a person skilled in the art without making creative efforts are within the scope of protection of the present application.

### Example 1

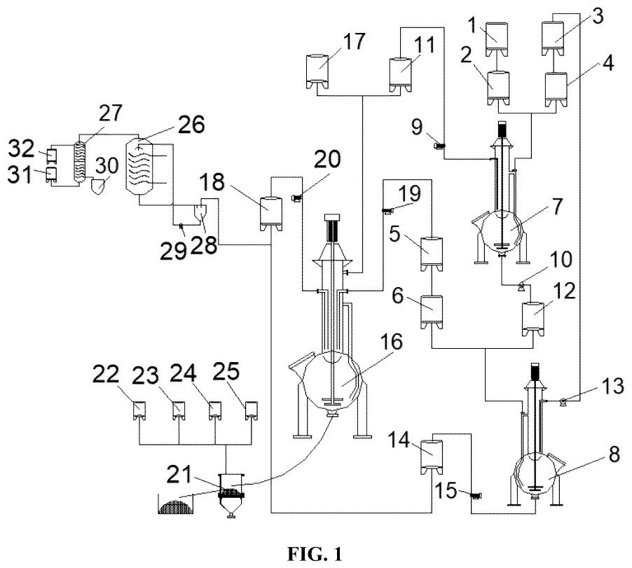

According to the embodiments of the present application, a gold recovery system from a gold separation solution is provided, as shown in FIG. 1, including a gold selective extraction system, a reduction system, a washing system, and an evaporation system;
in the above, the gold selective extraction system includes a gold separation solution mixer 1, a gold separation solution metering tank 2, a gold-carrying solution storage tank 3, a gold-carrying solution metering tank 4, an extractant storage tank 5, an extractant metering tank 6, a first extraction reactor 7, a second extraction reactor 8, a gold-rich solution pump 9, a secondary gold separation solution pump 10, a gold-rich solution storage tank 11, a secondary gold separation solution mixer 12, a gold-carrying solution pump 13, a gold-barren solution mixer 14 and a gold-barren solution pump 15; the gold separation solution mixer 1 is connected to the gold separation solution metering tank 2 and the first extraction reactor 7 in sequence, the gold-carrying solution storage tank 3 is connected to the gold-carrying solution metering tank 4 and the first extraction reactor 7 in sequence, the extractant storage tank 5 is connected to the extractant metering tank 6 and the first extraction reactor 7 in sequence (not shown in the figure), the first extraction reactor 7 is connected to the gold-rich solution pump 9, the gold-rich solution storage tank 11, and the reduction system in sequence; the extractant storage tank 5 is connected to the extractant metering tank 6 and the second extraction reactor 8 in sequence, the first extraction reactor 7 is connected to the secondary gold separation solution pump 10, the secondary gold separation solution mixer 12, and the second extraction reactor 8 in sequence, the second extraction reactor 8 is connected to the gold-carrying solution pump 13 and the gold-carrying solution storage tank 3 in sequence, and the second extraction reactor 8 is connected to the gold-barren solution pump 15, the gold-barren solution mixer 14, and the evaporation system in sequence;
the reduction system includes a reduction reactor 16, a reduction agent preparation tank 17, a post-reduction solution storage tank 18, an oil phase pump 19, and a liquid phase pump 20; and the gold-rich solution storage tank 11 is connected to the reduction reactor 16 and the washing system in sequence, the reduction agent preparation tank 17 is connected to the reduction reactor 16, the reduction reactor 16 is connected to the oil phase pump 19 and the extractant storage tank 5 in sequence, and the reduction reactor 16 is connected to the liquid phase pump 20, the post-reduction solution storage tank 18, and the evaporation system in sequence;
the washing system includes a washing barrel 21, a hydrochloric acid washing tank 22, a nitric acid washing tank 23, an ammonia washing tank 24 and a pure water washing tank 25; and the reduction reactor 16 is connected to the washing barrel 21, and the hydrochloric acid washing tank 22, the nitric acid washing tank 23, the ammonia washing tank 24 and the pure water washing tank 25 are respectively connected to the washing barrel 21; and
the evaporation system includes an evaporator 26, a condenser 27, a circulation tank 28, a circulation pump 29, an acid solution tank 30, a cold water barrel 31, and a hot water barrel 32; and the gold-barren solution mixer 14 and the post-reduction solution storage tank 18 are respectively connected to the circulation tank 28, the circulation pump 29, the evaporator 26, the condenser 27, and the acid solution tank 30 in sequence, and the cold water barrel 31 and the hot water barrel 32 are respectively connected to the condenser 27.

### Example 2

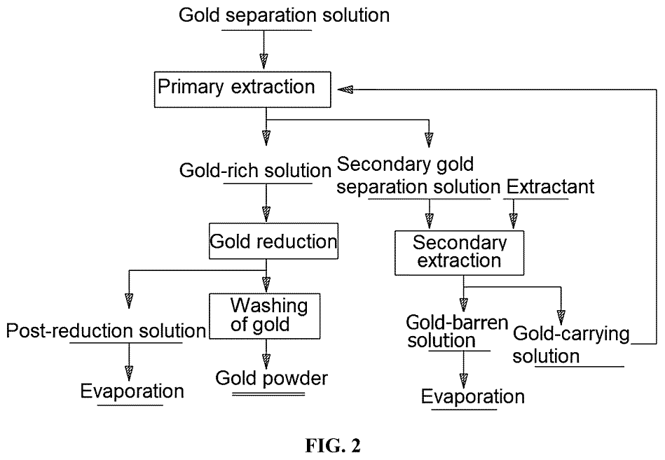

According to an embodiment of the present application, a gold recovery method from a gold separation solution was provided, as shown in FIG. 2, and specifically included the following steps:

### (1) Primary Extraction

discharging the gold separation solution in the gold separation solution mixer 1 to the first extraction reactor 7 via the gold separation solution metering tank 2, discharging the extractant A in the extractant storage tank 5 to the first extraction reactor 7 via the extractant metering tank 6, then starting the agitator of the first extraction reactor 7 to make the gold separation solution and the extractant in a volume ratio of 1:1 fully react at 25° C. for 2 h, standing for separation to obtain a gold-rich solution and a secondary gold separation solution respectively, and finally, discharging the gold-rich solution to the gold-rich solution storage tank 11 via the gold-rich solution pump 9, and discharging the secondary gold separation solution to the secondary gold separation solution mixer 12 via the secondary gold separation solution pump 10;
where the gold separation solution was a gold separation solution produced by chlorination gold separation from copper anode decopperized slag, with the composition as follows: Au 0.30 g/L, Ag 0.15 g/L, Pt 3 mg/L, Pd 30 mg/L, Se 1.5 g/L, Te 10 g/L, Bi 8 g/L, As 4 g/L, and Cu 0.6 g/L;
where the extractant A was a mixed solution of pillararene and chloroform, and the molar concentration ratio of the two was (8-10):1;

### (2) Secondary Extraction

discharging the secondary gold separation solution in the secondary gold separation solution mixer 12 to the second extraction reactor 8, discharging the extractant B in the extractant storage tank 5 to the second extraction reactor 8 via the extractant metering tank 6, then starting the agitator of the second extraction reactor 8 to make the secondary gold separation solution and the extractant in a volume ratio of 1:0.8 fully react at 25° C. for 2 h, standing for separation to obtain a gold-carrying solution and a gold-barren solution respectively, and finally, discharging the gold-carrying solution to the gold-carrying solution storage tank 3 via the gold-carrying solution pump 13, and discharging the gold-barren solution to the gold-barren solution mixer 14 via the gold-barren solution pump 15;
where the extractant B was a mixed solution of pillararene and chloroform, and the molar concentration ratio of the two was (15-20):1;

### (3) Gold Precipitation by Reduction

discharging the gold-rich solution in the gold-rich solution storage tank 11 to the reduction reactor 16, starting the agitator of the reduction reactor 16, heating to 85° C., then discharging the reduction agent in the reduction agent preparation tank 17 to the reduction reactor 16, making the gold-rich solution fully react with 1.5 times its mass of the reduction agent for 4 h, cooling, standing for separation to obtain an extractant, a post-reduction solution, and gold powder respectively, and finally, discharging the extractant to the extractant storage tank 5 via an oil phase pump 19, discharging the post-reduction solution to the post-reduction solution storage tank 18 via a liquid phase pump 20 and discharging the gold powder to the washing barrel 21 via a bottom valve of the reduction reactor 16;

### (4) Washing of Gold Powder

introducing the steam to the washing barrel 21 for hot washing; discharging the hydrochloric acid in the hydrochloric acid washing tank 22 to the washing barrel 21, soak washing, filtering, discharging the obtained hydrochloric acid concentrated solution to the hydrochloric acid washing tank 22, discharging the pure water in the pure water washing tank 25 to the washing barrel 21 and washing until neutral; discharging the ammonia water in the ammonia washing tank 24 to the washing barrel 21, soak washing, filtering, and discharging the obtained ammonia concentrated solution to the ammonia washing tank 24, discharging the pure water in the pure water washing tank 25 to the washing barrel 21 and washing until neutral; discharging the nitric acid in the nitric acid washing tank 23 to the washing barrel 21, soak washing, filtering, discharging the obtained nitric acid concentrated solution to the nitric acid washing tank 23, and discharging the pure water in the pure water washing tank 25 to the washing barrel 21 and washing until neutral; and drying the gold powder in the washing barrel 21 to obtain the gold powder product; and

### (5) Evaporation of Waste Solution

discharging the gold-barren solution in the gold-barren solution mixer 14 and the post-reduction solution in the post-reduction solution storage tank 18 to the evaporator 26 via the circulation tank 28 and the circulation pump 29 respectively, simultaneously opening the steam valve of the evaporator 26, and adjusting the opening degree for evaporation and concentration to obtain a gold-barren solution concentrate, a post-reduction solution concentrate, and an evaporated acid mist respectively, where the steam flow rate for evaporation and concentration was 0.5 m³/h, and the circulation flow rate of the gold-barren solution and the post-reduction solution was 80 L/h; further recovering valuable metals selenium and tellurium from the gold-barren solution concentrate, returning the post-reduction solution concentrate to the reduction agent preparation tank 17, discharging the evaporated acid mist to the condenser 27, and simultaneously opening the cold water barrel 31 and the hot water barrel 32 for condensation, where the flow rate of cooling water for condensation was 50 L/h; and discharging the resulting acid solution to the acid solution tank 30.

### Example 3

According to an embodiment of the present application, a gold recovery method from a gold separation solution was provided, as shown in FIG. 2, and specifically included the following steps:

### (1) Primary Extraction

discharging the gold separation solution in the gold separation solution mixer 1 to the first extraction reactor 7 via the gold separation solution metering tank 2, discharging the extractant A in the extractant storage tank 5 to the first extraction reactor 7 via the extractant metering tank 6, then starting the agitator of the first extraction reactor 7 to make the gold separation solution and the extractant in a volume ratio of 1:0.8 fully react at 25° C. for 2 h, standing for separation to obtain a gold-rich solution and a secondary gold separation solution respectively, and finally discharging the gold-rich solution to the gold-rich solution storage tank 11 via the gold-rich solution pump 9, and discharging the secondary gold separation solution to the secondary gold separation solution mixer 12 via the secondary gold separation solution pump 10;
where the gold separation solution was a gold separation solution produced by chlorination gold separation from copper anode decopperized slag, with the composition as follows: Au 0.30 g/L, Ag 0.15 g/L, Pt 3 mg/L, Pd 30 mg/L, Se 1.5 g/L, Te 10 g/L, Bi 8 g/L, As 4 g/L, and Cu 0.6 g/L;
where the extractant A was a mixed solution of pillararene and chloroform, and the molar concentration ratio of the two was (8-10):1;

### (2) Secondary Extraction

discharging the secondary gold separation solution in the secondary gold separation solution mixer 12 to the second extraction reactor 8, discharging the extractant B in the extractant storage tank 5 to the second extraction reactor 8 via the extractant metering tank 6, then starting the agitator of the second extraction reactor 8 to make the secondary gold separation solution and the extractant in a volume ratio of 1:1 fully react at 25° C. for 2 h, standing for separation to obtain a gold-carrying solution and a gold-barren solution respectively, and finally, discharging the gold-carrying solution to the gold-carrying solution storage tank 3 via the gold-carrying solution pump 13, and discharging the gold-barren solution to the gold-barren solution mixer 14 via the gold-barren solution pump 15;
where the extractant B was a mixed solution of pillararene and chloroform, and the molar concentration ratio of the two was (15-20):1;

### (3) Gold Precipitation by Reduction

discharging the gold-rich solution in the gold-rich solution storage tank 11 to the reduction reactor 16, starting the agitator of the reduction reactor 16, heating to 90° C., then discharging the reduction agent in the reduction agent preparation tank 17 to the reduction reactor 16, making the gold-rich solution fully react with 1.5 times its mass of the reduction agent for 5 h, cooling, standing for separation to obtain an extractant, a post-reduction solution, and gold powder respectively, and finally, discharging the extractant to the extractant storage tank 5 via the oil phase pump 19, discharging the post-reduction solution to the post-reduction solution storage tank 18 via the liquid phase pump 20, and discharging the gold powder to the washing barrel 21 via a bottom valve of the reduction reactor 16;

### (4) Washing of Gold Powder

introducing the steam to the washing barrel 21 for hot washing; discharging the hydrochloric acid in the hydrochloric acid washing tank 22 to the washing barrel 21, soak washing, filtering, discharging the obtained hydrochloric acid concentrated solution to the hydrochloric acid washing tank 22, discharging the pure water in the pure water washing tank 25 to the washing barrel 21 and washing until neutral; discharging the ammonia water in the ammonia washing tank 24 to the washing barrel 21, soak washing, filtering, and discharging the obtained ammonia concentrated solution to the ammonia washing tank 24, discharging the pure water in the pure water washing tank 25 to the washing barrel 21 and washing until neutral; discharging the nitric acid in the nitric acid washing tank 23 to the washing barrel 21, soak washing, filtering, discharging the obtained nitric acid concentrated solution to the nitric acid washing tank 23, and discharging the pure water in the pure water washing tank 25 to the washing barrel 21 and washing until neutral; and drying the gold powder in the washing barrel 21 to obtain the gold powder product; and

### (5) Evaporation of Waste Solution

discharging the gold-barren solution in the gold-barren solution mixer 14 and the post-reduction solution in the post-reduction solution storage tank 18 to the evaporator 26 via the circulation tank 28 and the circulation pump 29 respectively, simultaneously opening the steam valve of the evaporator 26, and adjusting the opening degree for evaporation and concentration to obtain a gold-barren solution concentrate, a post-reduction solution concentrate, and an evaporated acid mist respectively, where the steam flow rate for evaporation and concentration was 0.5 m³/h, and the circulation flow rate of the gold-barren solution and the post-reduction solution was 80 L/h; further recovering valuable metals selenium and tellurium from the gold-barren solution concentrate, returning the post-reduction solution concentrate to the reduction agent preparation tank 17, discharging the evaporated acid mist to the condenser 27, and simultaneously opening the cold water barrel 31 and the hot water barrel 32 for condensation, where the flow rate of cooling water for condensation was 50 L/h; and discharging the resulting acid solution to the acid solution tank 30.

### Example 4

According to an embodiment of the present application, a gold recovery method from a gold separation solution was provided, as shown in FIG. 2, and specifically included the following steps:

### (1) Primary Extraction

discharging the gold separation solution in the gold separation solution mixer 1 to the first extraction reactor 7 via the gold separation solution metering tank 2, discharging the extractant A in the extractant storage tank 5 to the first extraction reactor 7 via the extractant metering tank 6, then starting the agitator of the first extraction reactor 7 to make the gold separation solution and the extractant in a volume ratio of 1:1 fully react at 25° C. for 3 h, standing for separation to obtain a gold-rich solution and a secondary gold separation solution respectively, and finally, discharging the gold-rich solution to the gold-rich solution storage tank 11 via the gold-rich solution pump 9, and discharging the secondary gold separation solution to the secondary gold separation solution mixer 12 via the secondary gold separation solution pump 10;
where the gold separation solution was a gold separation solution produced by chlorination gold separation from copper anode decopperized slag, with the composition as follows: Au 0.30 g/L, Ag 0.15 g/L, Pt 3 mg/L, Pd 30 mg/L, Se 1.5 g/L, Te 10 g/L, Bi 8 g/L, As 4 g/L, and Cu 0.6 g/L;
where the extractant A was a mixed solution of pillararene and chloroform, and the molar concentration ratio of the two was (8-10):1;

### (2) Secondary Extraction

discharging the secondary gold separation solution in the secondary gold separation solution mixer 12 to the second extraction reactor 8, discharging the extractant B in the extractant storage tank 5 to the second extraction reactor 8 via the extractant metering tank 6, then starting the agitator of the second extraction reactor 8 to make the secondary gold separation solution and the extractant in a volume ratio of 1:0.8 fully react at 25° C. for 1 h, standing for separation to obtain a gold-carrying solution and a gold-barren solution respectively, and finally, discharging the gold-carrying solution to the gold-carrying solution storage tank 3 via the gold-carrying solution pump 13, and discharging the gold-barren solution to the gold-barren solution mixer 14 via the gold-barren solution pump 15;
where the extractant B was a mixed solution of pillararene and chloroform, and the molar concentration ratio of the two was (15-20):1;

### (3) Gold Precipitation by Reduction

discharging the gold-rich solution in the gold-rich solution storage tank 11 to the reduction reactor 16, starting the agitator of the reduction reactor 16, heating to 95° C., then discharging the reduction agent in the reduction agent preparation tank 17 to the reduction reactor 16, making the gold-rich solution fully react with 1.5 times its mass of the reduction agent for 6 h, cooling, standing for separation to obtain an extractant, a post-reduction solution, and gold powder respectively, and finally, discharging the extractant to the extractant storage tank 5 via the oil phase pump 19, discharging the post-reduction solution to the post-reduction solution storage tank 18 via the liquid phase pump 20, and discharging the gold powder to the washing barrel 21 via a bottom valve of the reduction reactor 16;

### (4) Washing of Gold Powder

introducing the steam to the washing barrel 21 for hot washing; discharging the hydrochloric acid in the hydrochloric acid washing tank 22 to the washing barrel 21, soak washing, filtering, discharging the obtained hydrochloric acid concentrated solution to the hydrochloric acid washing tank 22, discharging the pure water in the pure water washing tank 25 to the washing barrel 21 and washing until neutral; discharging the ammonia water in the ammonia washing tank 24 to the washing barrel 21, soak washing, filtering, and discharging the obtained ammonia concentrated solution to the ammonia washing tank 24, discharging the pure water in the pure water washing tank 25 to the washing barrel 21 and washing until neutral; discharging the nitric acid in the nitric acid washing tank 23 to the washing barrel 21, soak washing, filtering, discharging the obtained nitric acid concentrated solution to the nitric acid washing tank 23, and discharging the pure water in the pure water washing tank 25 to the washing barrel 21 and washing until neutral; and drying the gold powder in the washing barrel 21 to obtain the gold powder product; and

### (5) Evaporation of Waste Solution

discharging the gold-barren solution in the gold-barren solution mixer 14 and the post-reduction solution in the post-reduction solution storage tank 18 to the evaporator 26 via the circulation tank 28 and the circulation pump 29 respectively, simultaneously opening the steam valve of the evaporator 26, and adjusting the opening degree for evaporation and concentration to obtain a gold-barren solution concentrate, a post-reduction solution concentrate, and an evaporated acid mist respectively, where the steam flow rate for evaporation and concentration was 0.5 m³/h, and the circulation flow rate of the gold-barren solution and the post-reduction solution was 80 L/h; further recovering valuable metals selenium and tellurium from the gold-barren solution concentrate, returning the post-reduction solution concentrate to the reduction agent preparation tank 17, discharging the evaporated acid mist to the condenser 27, and simultaneously opening the cold water barrel 31 and the hot water barrel 32 for condensation, where the flow rate of cooling water for condensation was 50 L/h; and discharging the resulting acid solution to the acid solution tank 30.

### Performance Testing

The gold powder products (sponge gold) prepared in Examples 2-4 were tested and analyzed according to the GB/T4134-2021 standard. The results were as shown in Table 1.

TABLE 1
Gold Contents of Gold Powder Products of Examples 2-4

| Gold powder product | Example 2 | Example 3 | Example 4 |
|---|---|---|---|
| Gold content % | 99.995 | 99.995 | 99.995 |

It can be seen from Table 1 that the gold contents of the gold powder products of Examples 2-4 of the present application reach 99.995%.

The above experiments show that in the present application, by using chloride ions to recognize AuCl₄⁻, the gold-rich solution is directly reduced to produce qualified gold powder products (99.995%); the gold-barren solution and the post-reduction solution are evaporated and concentrated, with the condensate reused to realize the recovery and regeneration of chloride ions, the recycling of the extractant, and no generation of waste solution or waste gas in the production process.

Although the embodiments of the present application have been shown and described above, it can be understood that the above embodiments are exemplary and cannot be understood as limitations thereon. The person ordinarily skilled in the art may make changes, modifications, substitutions and variations to the above embodiments within the scope thereof.

### INDUSTRIAL APPLICABILITY

The gold recovery system and recovery method thereof from the gold separation solution of the present application uses chloride ions to recognize AuCl₄⁻, so that the gold-rich solution is directly reduced to produce qualified gold powder products (99.995%), the gold-barren solution and the post-reduction solution are evaporated and concentrated, and the condensates are reused to achieve recovery and regeneration of chloride ions, the recycling of the extractant, and no generation of waste solution or waste gas in the production process.

1. A gold recovery system from a gold separation solution, comprising a gold selective extraction system, a reduction system, a washing system and an evaporation system;
wherein the gold selective extraction system comprises a gold separation solution mixer, a gold separation solution metering tank, a gold-carrying solution storage tank, a gold-carrying solution metering tank, an extractant storage tank, an extractant metering tank, a first extraction reactor, a second extraction reactor, a gold-rich solution pump, a secondary gold separation solution pump, a gold-rich solution storage tank, a secondary gold separation solution mixer, a gold-carrying solution pump, a gold-barren solution mixer and a gold-barren solution pump; the gold separation solution mixer is connected to the gold separation solution metering tank and the first extraction reactor in sequence, the gold-carrying solution storage tank is connected to the gold-carrying solution metering tank and the first extraction reactor in sequence, the extractant storage tank is connected to the extractant metering tank and the first extraction reactor in sequence, and the first extraction reactor is connected to the gold-rich solution pump, the gold-rich solution storage tank, and the reduction system in sequence; and the extractant storage tank is connected to the extractant metering tank and the second extraction reactor in sequence, the first extraction reactor is connected to the secondary gold separation solution pump, the secondary gold separation solution mixer, and the second extraction reactor in sequence, the second extraction reactor is connected to the gold-carrying solution pump and the gold-carrying solution storage tank in sequence, and the second extraction reactor is connected to the gold-barren solution pump, the gold-barren solution mixer, and the evaporation system in sequence;
the reduction system comprises a reduction reactor, a reduction agent preparation tank, a post-reduction solution storage tank, an oil phase pump and a liquid phase pump; and the gold-rich solution storage tank is connected to the reduction reactor and the washing system in sequence, the reduction agent preparation tank is connected to the reduction reactor, the reduction reactor is connected to the oil phase pump and the extractant storage tank in sequence, and the reduction reactor is connected to the liquid phase pump, the post-reduction solution storage tank and the evaporation system in sequence;
the washing system comprises a washing barrel, a hydrochloric acid washing tank, a nitric acid washing tank, an ammonia washing tank and a pure water washing tank; and the reduction reactor is connected to the washing barrel, and the hydrochloric acid washing tank, the nitric acid washing tank, the ammonia washing tank and the pure water washing tank are respectively connected to the washing barrel; and
the evaporation system comprises an evaporator, a condenser, a circulation tank, a circulation pump, an acid solution tank, a cold water barrel and a hot water barrel; and the gold-barren solution mixer and the post-reduction solution storage tank are respectively connected to the circulation tank, the circulation pump, the evaporator, the condenser and the acid solution tank in sequence, and the cold water barrel and the hot water barrel are respectively connected to the condenser.

2. A gold recovery method from a gold separation solution, wherein the recovery system according to claim 1 is used, and the method comprises steps of:
(1) primary extraction
discharging a gold separation solution in the gold separation solution mixer to the first extraction reactor via the gold separation solution metering tank, discharging an extractant A in the extractant storage tank to the first extraction reactor via the extractant metering tank, then starting an agitator of the first extraction reactor to make the gold separation solution and the extractant fully react, standing for separation to obtain a gold-rich solution and a secondary gold separation solution respectively, and finally, discharging the gold-rich solution to the gold-rich solution storage tank via the gold-rich solution pump, and discharging the secondary gold separation solution to the secondary gold separation solution mixer via the secondary gold separation solution pump;
(2) secondary extraction
discharging the secondary gold separation solution in the secondary gold separation solution mixer to the second extraction reactor, discharging an extractant B in the extractant storage tank to the second extraction reactor via the extractant metering tank, then starting an agitator of the second extraction reactor to make the secondary gold separation solution and the extractant fully react, standing for separation to obtain a gold-carrying solution and a gold-barren solution respectively, and finally discharging the gold-carrying solution to the gold-carrying solution storage tank via the gold-carrying solution pump, and discharging the gold-barren solution to the gold-barren solution mixer via a gold-barren solution pump;
(3) gold precipitation by reduction
discharging the gold-rich solution in the gold-rich solution storage tank to the reduction reactor, starting an agitator of the reduction reactor, heating, then discharging a reduction agent in the reduction agent preparation tank to the reduction reactor, making the gold-rich solution and the reduction agent fully react, cooling, standing for separation to obtain an extractant, a post-reduction solution, and gold powder respectively, and finally, discharging the extractant to the extractant storage tank via the oil phase pump, discharging the post-reduction solution to the post-reduction solution storage tank via the liquid phase pump, and discharging the gold powder to the washing barrel via a bottom valve of the reduction reactor;
(4) washing of gold powder
introducing a steam to the washing barrel for hot washing; discharging hydrochloric acid in the hydrochloric acid washing tank to the washing barrel, soak washing, filtering, discharging an obtained hydrochloric acid concentrated solution to the hydrochloric acid washing tank, and discharging pure water in the pure water washing tank to the washing barrel and washing until neutral; discharging ammonia water in the ammonia washing tank to the washing barrel, soak washing, filtering, discharging an obtained ammonia concentrated solution to the ammonia washing tank, and discharging the pure water in the pure water washing tank to the washing barrel and washing until neutral; discharging nitric acid in the nitric acid washing tank to the washing barrel, soak washing, filtering, discharging an obtained nitric acid concentrated solution to the nitric acid washing tank, and discharging the pure water in the pure water washing tank to the washing barrel and washing until neutral; and drying the gold powder in the washing barrel to obtain a gold powder product; and
(5) evaporation of waste solution
discharging the gold-barren solution in the gold-barren solution mixer and the post-reduction solution in the post-reduction solution storage tank to the evaporator via the circulation tank and the circulation pump respectively, simultaneously opening a steam valve of the evaporator, adjusting an opening degree for evaporation and concentration to obtain a gold-barren solution concentrate, a post-reduction solution concentrate and an evaporated acid mist respectively, further recovering valuable metals selenium and tellurium from the gold-barren solution concentrate, returning the post-reduction solution concentrate to the reduction agent preparation tank, discharging the evaporated acid mist to the condenser, and simultaneously opening the cold water barrel and the hot water barrel for condensation, and discharging an obtained acid solution to the acid solution tank.

3. The gold recovery method from a gold separation solution according to claim 2, wherein in step (1), a composition of the gold separation solution comprises: Au 0.30-0.38 g/L, Ag 0.05-0.15 g/L, Pt 3 mg/L, Pd 30 mg/L, Se 0.9-1.5 g/L, Te 10-13 g/L, Bi 8 g/L, As 4 g/L and Cu 0.6-1.3 g/L.

4. The gold recovery method from a gold separation solution according to claim 2, wherein in step (1), the extractant A is a mixed solution of pillararene and chloroform.

5. The gold recovery method from a gold separation solution according to claim 4, wherein in step (1), a molar concentration ratio of pillararene to chloroform is (8-10):1.

6. The gold recovery method from a gold separation solution according to claim 2, wherein in step (1), a volume ratio of the gold separation solution to the extractant is 1:(0.8-1).

7. The gold recovery method from a gold separation solution according to claim 2, wherein in step (1), the reacting is performed at a temperature of 25° C. for a time is 2-3 h.

8. The gold recovery method from a gold separation solution according to claim 2, wherein in step (2), the extractant B is a mixed solution of pillararene and chloroform.

9. The gold recovery method from a gold separation solution according to claim 8, wherein in step (2), a molar concentration ratio of pillararene to chloroform is (15-20):1.

10. The gold recovery method from a gold separation solution according to claim 2, wherein in step (2), a volume ratio of the secondary gold separation solution to the extractant is 1:(0.8-1).

11. The gold recovery method from a gold separation solution according to claim 2, wherein in step (2), the reacting is performed at a temperature of 25° C. for a time of 1-2 h.

12. The gold recovery method from a gold separation solution according to claim 2, wherein in step (3), the reduction agent is ammonium oxalate.

13. The gold recovery method from a gold separation solution according to claim 12, wherein in step (3), a dosage of ammonium oxalate is 1.5 times a mass of gold in the gold-rich solution.

14. The gold recovery method from a gold separation solution according to claim 2, wherein in step (3), the reacting is performed at a temperature of 85-95° C. for a time of 4-6 h.

15. The gold recovery method from a gold separation solution according to claim 2, wherein in step (5), a steam flow rate of the evaporation and concentration is 0.5 m³/h.

16. The gold recovery method from a gold separation solution according to claim 2, wherein in step (5), a circulation flow rate of the gold-barren solution and the post-reduction solution is 80 L/h.

17. The gold recovery method from a gold separation solution according to claim 2, wherein in step (5), a flow rate of cooling water for the condensation is 50 L/h.
